(19) United States
(12) Patent Application Publication
(10) Pub. No.: US 2002/0088339 A1
(43) Pub. Date: Jul. 11, 2002

(54) BULLET COLLECTOR

(76) Inventor: Scott C. Koffler, Eugene, OR (US)

Correspondence Address: James D. Givnan. Jr., 8175 S. W. Ernst Road, Portland, OR, 97225, US

(21) Appl. No.: 09/757,862

(22) Filed: Jan. 11, 2001

(51) Int. Cl. F41H 5/02; B64D 1/04; F41F 5/00

(52) U.S. Cl. 89/36.02

(57) ABSTRACT

A tubular structure is supported on a base and contains material which saps the energy of a bullet fired into the upper end of the structure. A cap assembly closes the upper end and includes pliable ears which yield to close about the barrel of a firearm. A shield is offset from the structure and is transparent.

### BACKGROUND OF THE INVENTION

The present invention concerns devices for the collection of bullets fired from hand guns and containing a material which serves to absorb bullet energy.

Known in the present art are devices used in gun shops and shooting galleries for the collection of bullets and, in the former, used primarily in the checking of hand gun operation.

In the prior art exists several patents disclosing tubular structures partially filled with a particulate which absorbs bullet forces. Some of the devices disclosed include a collection of sand or other granular material for stopping bullets discharged into the an open end of the tubular structure.

U.S. Design patent 162,376 discloses a tubular structure supported on casters having an opening at its upper end for the reception of bullets fired in a shooting gallery.

U.S. Pat. No. 2,613,934 discloses a wheel supported tubular structure which serves as a portable target with an upper or open end partially closed by a segment-shaped shield for a light bulb.

U.S. Pat. No. 2,607,959 discloses a tubular structure similar to that disclosed in the above noted design patent but with provision made for suspension of a target within the lower end of the tubular structure which additionally confines a layer of sand

U.S. Pat. No. 4,475,734 discloses a bullet collector utilizing a downwardly inclined plate within a housing partially filled with water for absorbing bullet energy. The inclined plate deflects bullets toward the water filled chamber.

U.S. Pat. No. 4,821,620 discloses a metal shield having a forwardly offset rubber sheet permitting bullet penetration with the metal shield stopping the bullet with bullet fragments gravitating downwardly in an area between the shield and rubber sheet. The area terminates downwardly in a collector for the bullet and bullet fragments.

U.S. Pat. No. 5,259,291 discloses a structure for supporting a flexible self-sealing material of curtain shape with bullets passing therethrough contacting an inclined plate which, along with a lower offset plate, directs bullets and fragments into a receptacle.

U.S. Pat. No. 6,016,735 discloses an inclined cylinder having a rubber disk-line partition therein with a bullet collection area behind the partition filled with random shaped metal pieces. A sleeve within the device defines exhaust ports for exhausting the blast occurring with firing of a hand gun with the muzzle inserted into proximity of the disk-like partition.

### SUMMARY OF THE INVENTION

The present invention concerns generally a device for permitting the firing of hand guns in a gun shop or other repair facility without risk of bullets or bullet fragments injuring the user or a bystander and with partial noise abatement.

The present bullet collector utilizes an inclined tubular structure supported at its base by a platform which may be equipped with casters. The tubular structure is charged with sand or other material to dissipate bullet velocity without risk bullet fragmenting to complicate the task of separating the bullets and sand or other material absorbing bullet forces. A cap structure closes the upper end of the tubular structure and includes a pliable member which closes about a hand gun barrel. The closure member includes multiple members which permit flexing of the closure in a close fitting manner about the hand gun barrel to inhibit the escape of sand or other material from the tubular structure. The closure is clamped to the tubular structure to facilitate replacement. Further, a shield of transparent material permits a user to verify the inserted relationship of the hand gun with the closure before firing of the weapon. The shield additionally serves as a guard to prevent any blast from approaching the user's eyes or face as well as to diminish sound waves.

Important features of the present invention include the provision of a tubular structure into which bullets are fired from a hand gun held in place proximate the distal end of the tubular structure and inserted through a pliable closure about the hand gun barrel; the provision of a bullet receptacle having a pliable closure slotted to provide highly flexible segments which fit closely about a gun barrel inserted therethrough to minimize return gas or particle; the provision of a bullet receptacle having a closure at one end for inserted passage of a hand gun and a safety shield offset from the upper end of the tubular structure to permit verifying hand gun position and protecting the user's face and eyes should the blast or particles escape from the tubular structure.

### BRIEF DESCRIPTION OF THE DRAWINGS

With regard to the accompanying drawings wherein:

FIG. 1 is a side elevational view of the present bullet collector with the unseen side being a mirror image thereof;

FIG. 2 is a sectional view taken along line 2-2 of FIG. 1; and

FIG. 3 is an end elevational view taken along line 3-3 of FIG. 1.

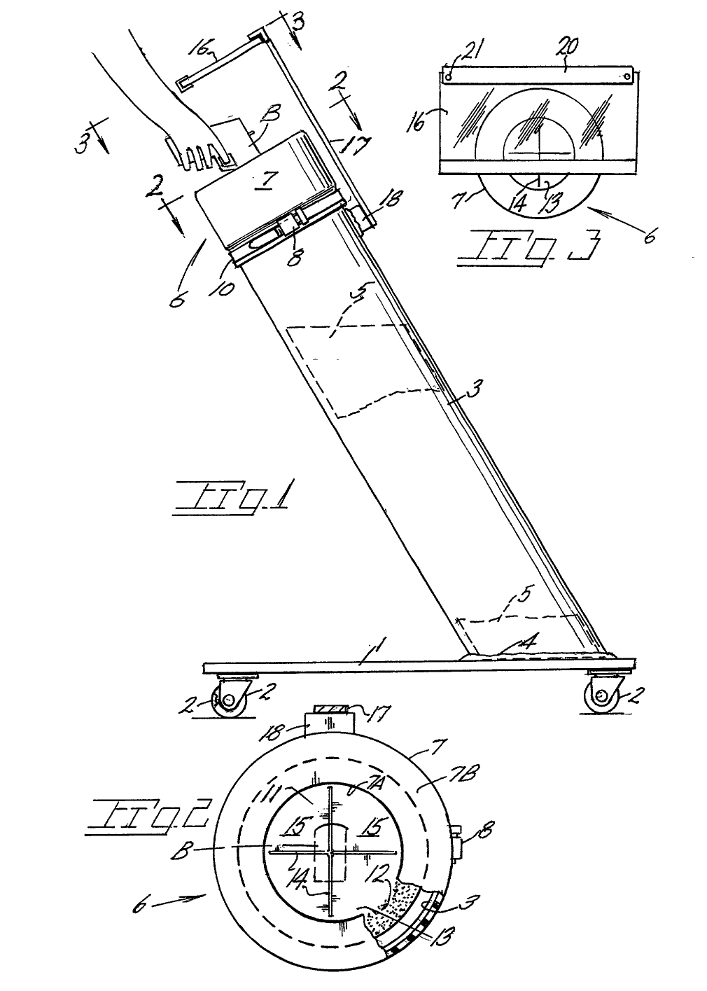

### DETAILED DESCRIPTION OF THE PREFERRED EMBODIMENTS

With continuing attention to the drawings in which applied reference numerals indicate parts similarly hereinafter identified, the reference numeral 1 indicates a base or platform of the present device. Casters at 2 permit convenient placement of the device within a gun shop or other using facility.

A tubular structure 3, preferably of about six inches in diameter and of schedule 80 type, is secured by a weld 4 to base 1. Tubular structure 3 is inclined at approximately 65 degrees to facilitate use of the device as later provided. A quantity of sand or other particulate is indicated at 5 and preferably extends at least half way the length of structure 3 to ensure the stopping of bullets fired from a wide range of hand guns.

Indicated generally at 6 is a cap assembly serving to close the upper end of structure 3 and including an elastic sleeve 7 which extends partially across an open end of structure 3 and down a portion thereof to overlie a distal end segment of the structure. A clamp 8 secures a band 10 about sleeve 7 and against structure 3 in a snug manner. Sleeve 7 includes an inner edge 7A defining an open area 11 substantially concentric with the axis of tubular structure 3. Secured to an inner margin of sleeve 7 by an adhesive 12 is a rubber disk 13 slotted as at 14 to provide flexible members 15 shown as ears which flex inwardly to close against the barrel B of a hand gun shown in broken lines. Accordingly, the ears 15 close about the barrel of the hand gun to virtually restrict any blast or matrix particles from escaping tubular structure 3. The slits 14 show spaced apart edges for illustrative purposes only, and in practice the edges lie closed against their corresponding edge.

In assembly of the cap assembly the sleeve 7 is of a diameter to fit in a snug manner about the upper end segment of tubular structure 3 with an annular portion 7B of the cap extending partially across the open end of the structure. Rubber disk 13 is then applied, as by adhesive 12, to sleeve portion 7B to provide a close fit of flexible ears 15 about gun barrel B.

A shield at 16 is of transparent, shatter resistant material such as plexiglass to permit the user to verify proper positioning of a hand gun barrel, i.e., partially axially inserted through cap assembly 6. A bracket 17 is mounted at 18 to tubular structure 3 with an angle iron segment 20 is welded to the bracket to provide a rigid support for shield 16. Fasteners at 21 secure the shield to angle iron 20.

While I have shown but one embodiment of the invention, it will be apparent to those skilled in the art that the invention may be embodied still otherwise without departing from the spirit and scope of the claimed invention.

Having thus described the invention, what is desired to be secured by a Letters Patent is:

I claim:

1-A receptacle for bullets fired from hand guns including,
a base,
an elongate tubular structure for said base and in which a quantity of yieldable material is confined, and
a cap assembly of one end of said tubular structure including an expanse of pliable material having multiple flexible members displaceable by the inserted barrel of a hand gun, said multiple members constituting a barrier to the escape of material from the tubular structure.

2-The receptacle claimed in claim 1 wherein said cap assembly includes a sleeve in place about said one end of said tubular structure and a clamp securing said sleeve in place.

3-The receptacle claimed in claim 2 wherein said sleeve and said expanse of pliable material are adhesively joined.

4-The receptacle claimed in claim 1 wherein said flexible multiple members are embodied in ears are defined by corresponding edges on said expanse of pliable material.

5-The receptacle claimed in claim 1 additionally including a transparent shield, a bracket on said tubular structure and extending in an axial direction therefrom to support said shield offset from said one end of the tubular structure.
